(19) United States
(12) Patent Application Publication
(10) Pub. No.: US 2010/0011148 A1
(43) Pub. Date: Jan. 14, 2010

(54) Method and Apparatus to Facilitate Using a Policy to Modify a State-to-State Transition as Comprises a Part of an Agnostic Stored Model

(75) Inventors: John Strassner, North Barrington, IL (US); Mark Gannon, Sleepy Hollow, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/169,676

(22) Filed: Jul. 9, 2008

(51) Int. Cl. G06F 12/00

(52) U.S. Cl. 711/100; 711/E12.001

(57) ABSTRACT

A stored model is comprised of a plurality of candidate contextually-described states along with state-to-state transitions between at least some of this plurality of candidate contextually-described states. This stored model can be agnostic with respect to any particular application. One can then access at least one policy as pertains to a particular application to be effected by that platform and apply that policy to modify at least one of the state-to-state transitions to thereby provide a modified version of the stored model that corresponds in particular to the particular application to be effected. By one approach, the aforementioned policy can comprise, at least in part, an indication of a relative preference as pertains to one or more of the state-to-state transitions. This can comprise, for example, a weighting factor to be applied with respect to one or more of the state-to-state transitions.

### TECHNICAL FIELD

This invention relates generally to application processing and more particularly to the state-based processing of an application.

### BACKGROUND

Applications (such as, for example, software-implemented applications) of various kinds are known in the art. Increasingly, such applications must operate in ever more complex and dynamic operating application settings. To at least attempt to meet such changing operational circumstances in some agile manner, some systems employ the use of finite automata. By this approach, for example, the delivery of a service can correspond to a particular state or set of states as tend to characterize a given application setting.

Though conceptually a useful approach, such a technique can and will tend to lead to a very large number of candidate states. This, in turn, can greatly detract from the real time usability of such an approach as the computational capabilities of a given implementing platform may simply be unable to chum such a huge quantity of information, on a repetitive basis, within some useful period of time to permit state-based dynamic responses.

As a result, platforms and systems that seek to employ such an approach tend towards the use of highly customized and application-specific constructs in order to manage and limit such considerations. While often effective, such an approach necessarily burdens the development and fielding of new applications with the need to fully identify and build-out such a capability for each such new application. This can lead to the delayed introduction of new products and services, operational incompatibilities between system components that employ differing approaches in this regards, increased capital and maintenance costs, and corresponding end user dissatisfaction.

### BRIEF DESCRIPTION OF THE DRAWINGS

The above needs are at least partially met through provision of the method and apparatus to facilitate using a policy to modify a state-to-state transition as comprises a part of an agnostic stored model described in the following detailed description, particularly when studied in conjunction with the drawings, wherein:

FIG. 1 comprises a flow diagram that uses at least one policy to govern the state transition of a system as configured in accordance with various embodiments of the invention;

FIG. 2 comprises a schematic representation depicting how policy can be used to alter the cost of a given state transition as configured in accordance with various embodiments of the invention;

FIG. 3 comprises a schematic representation illustrating how meta-policies can be used to coordinate the actions of one or more policies to alter the cost of multiple segments of a state diagram as configured in accordance with various embodiments of the invention;

FIG. 4 comprises a schematic representation showing an exemplar state machine and the cost of its state transitions as configured in accordance with various embodiments of the invention;

FIG. 5 comprises a flow diagram describing how state transitions are determined based on knowledge from a combination of information models and ontologies as configured in accordance with various embodiments of the invention;

FIG. 6 comprises a flow diagram describing how context changes can be detected using a combination of information models and ontologies, and how such context changes can be related to one or more state transitions that need to be made to restore the system to its desired state as configured in accordance with various embodiments of the invention;

FIG. 7 comprises a block diagram of the overall system as configured in accordance with various embodiments of the invention; and

FIG. 8 comprises a block diagram of a networked version of the overall system as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an enabling platform accesses a stored model. This stored model is comprised of a plurality of candidate contextually-described states along with state-to-state transitions between at least some of this plurality of candidate contextually-described states. By one approach, this stored model is agnostic with respect to any particular application. This platform then accesses at least one policy as pertains to a particular application to be effected by that platform and applies that policy to modify at least one of the state-to-state transitions to thereby provide a modified version of the stored model that corresponds in particular to the particular application to be effected.

By one approach, this stored model can be retrieved from a location that is remote with respect to the platform itself. By another approach, this stored model can be retrieved instead from a location that is native with respect to the platform.

By one approach, the aforementioned policy can comprise, at least in part, an indication of a relative preference as pertains to one or more of the state-to-state transitions. This can comprise, for example, a weighting factor to be applied with respect to one or more of the state-to-state transitions. By one approach for example this can comprise applying a weighting factor that causes the cost of affected states to be lower than the cost of other alternate states, thereby causing the affected state to be chosen.

So configured, these teachings will then readily support using this modified version of the stored model when effecting the particular application by the platform to facilitate making automated transitions from one state to another.

Those skilled in the art will recognize and appreciate that these teachings can be beneficially employed to leverage the capabilities of numerous existing platforms and applications. It will further be understood that these teachings are highly scalable and can accommodate, for example, a virtually limitless quantity of applications that may otherwise differ quite greatly from one another with respect to which state-based criteria may be relevant to a given one of these applications. This, in turn, greatly eases the effort and difficulty that must be exerted when bringing such an application into the marketplace.

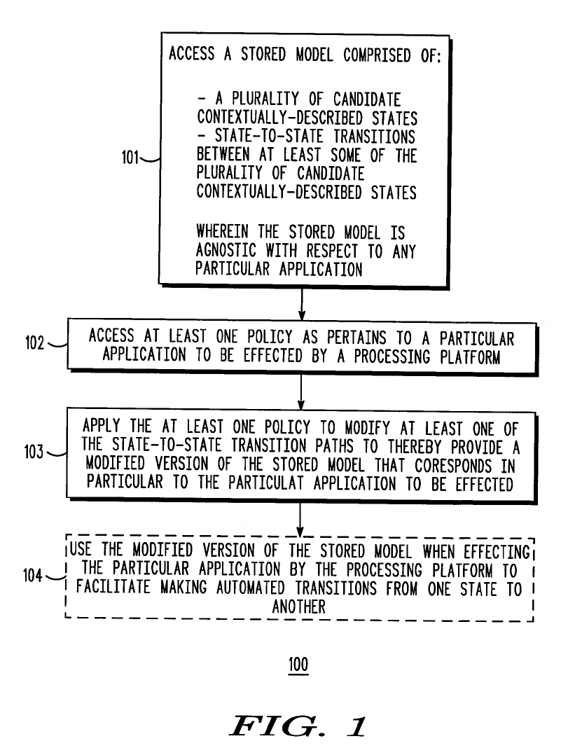

These and other benefits may become clearer upon making a thorough review and study of the following detailed description. Referring now to the drawings, and in particular to FIG. 1, an illustrative process that is compatible with many of these teachings will now be presented.

This process 100 includes the step 101 of accessing a stored model. This can comprise, for example, retrieving the stored model from a location that is remote with respect to the processing platform that is effecting this process 100. (As used herein, the expression “remote” will be understood to refer to either a significant physical separation (as when two objects are each physically located in discrete, separate, physically separated facilities such as two separate buildings) or a significant administrative separation (as when two objects are each administered and controlled by discrete, legally, and operatively separate entities)). As another example in these regards, this can also comprise retrieving the stored model from a location that is native with respect to the processing platform. (As used herein, the expression “native” refers to functionality that is an inherent presently-enabled capability of the platform itself; to illustrate, one native capability of an ordinary pencil is the ability to leave an erasable visible mark on a surface such as paper.)

By one approach, this retrieved stored model can comprise one of a plurality of candidate stored models. Using this approach, for example, each stored model can relate to a particular application genre. While any given model might be highly adept at accommodating a widely variable application space, the use of multiple models would permit some differentiation in this regard without necessarily compromising the benefit of simplifying the model selection process.

This retrieved stored model can be comprised, in part, of a plurality of candidate contextually-described states. As used herein, the expression “candidate” will be understood to refer to selections that are genuinely and substantively presently available for selectable use. For the purposes of these teachings, the context of any entity is a collection of knowledge and data that results from the set of all interrelated conditions in which that entity exists. Events point out changing conditions that may affect that entity, and actions are done to change or to maintain the state of that entity according to these conditions and actions.

This view, of course, supports the underlying thesis of context-aware applications. The relation of context to state enables the context of the object to be managed using, for example, finite state machines. This, in turn, comprises a useful fulcrum upon which these present teachings are usefully leveraged in a variety of application settings.

Those skilled in the art will recognize that context can have multiple distinct sets of related data and knowledge that are used to adjust a corresponding state in accordance with the changes in the corresponding environment. The well known DEN-ng model, for example, represents this as a set of aggregations to so-called ContextData (where ContextData is a class that focuses on one specific type of data and/or knowledge that is aggregated by the entity's context).

These contextually-described states mirror the notion that the context of an entity can be represented by a set of states. For example, the context of a person communicating using a cellular telephone can be represented by the state of the telephone itself, the state of the local operational environment, the state of the present geographic location, the state of the telephone's proximity to a corresponding cellular system antenna, and so forth. One advantage of using an information model to serve in such a representational capacity is that each of the principal entities that are contributing to context (i.e., the end user, the cellular telephone, the location, and so forth) can be modeled in as much detail as required for a given application. More importantly, and as per these present teachings, these models offer the potential to be reused for different applications.

The reuse of models offers the potential to form a library of modeled behaviors. Hence, the common components of context as well as entities that interact in a given context can be modeled and reused. By one approach, this can be done by mapping model elements (such as classes, attributes, associations, and so forth) to so-called nodes and edges in a state machine (and particularly so when the stored model comprises a graphic representation of this plurality of candidate contextually-described states).

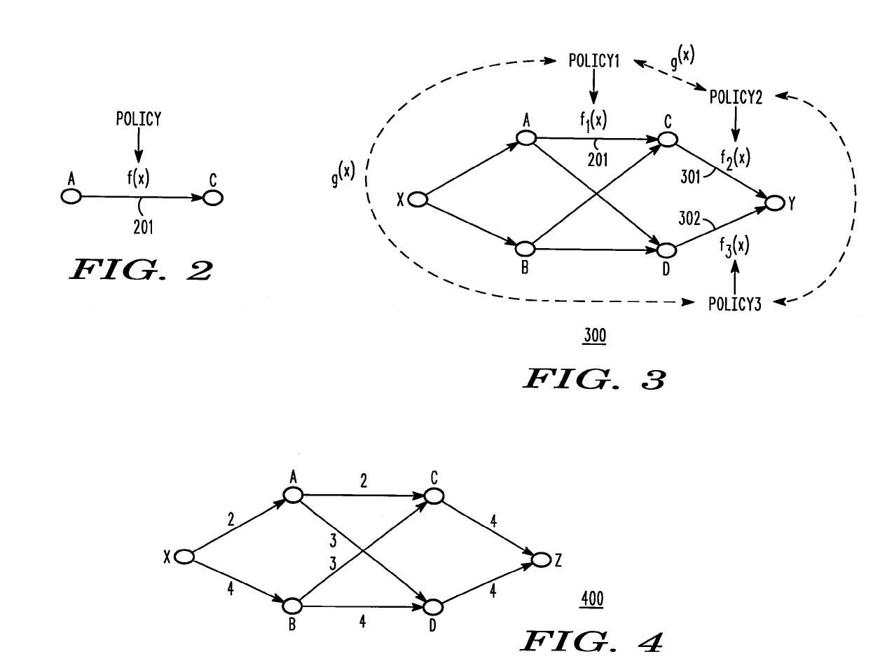

This stored model can also comprise state-to-state transitions between at least some of the plurality of candidate contextually-described states. These state-to-state transitions can equate directly with the aforementioned state machine edges. Viewed graphically, and referring momentarily to FIG. 2, one simple example in this regard presents two nodes representing a first state A and a second state C that are coupled by an edge 201 that represents the state-to-state transition from state A to state C.

A comprehensive context-aware application can require a detailed and extensible context-based model to represent its behavior. The aforementioned DEN-ng model can serve in this regard, but those skilled in the art will recognize and anticipate that building state machines via this approach to realize this flexibility will unfortunately typically result in a vast number of corresponding states. This can greatly complicate the task of orchestrating the use and application of context. For example, the sheer volume of resultant content can render it very difficult to identify for a given application experiencing a particular present context a useful (let alone an optimal) set of configuration commands to perform.

The applicant has determined that graph-theoretic algorithms are a powerful way to address this need. Generally speaking, these teachings will accommodate the use of any graph-theoretic mechanism and this, in turn, permits the resultant model to be viewed as a general template that can be customized to suit the needs of a particular application simply by changing the graphic mechanisms that are employed.

As this approach is based on mathematics, the corresponding results can be effectively proven and hence remove considerable speculation from the process. This, in turn, can lead to a secure conclusion that a particular state is not a correct state as well as a proven conclusion that a particular set of configurations (which corresponds, of course, to a transition to a new state) comprises a lowest cost path in the graph (which presumably describes all possible states for the managed system) and hence, as the lowest cost path, should be preferred over all other possible paths in the graph.

The aforementioned edges can serve to represent not only the transition from one state to another but can have associated therewith a corresponding so-called cost. (As used herein, the expression “cost” will be understood to refer to the desirability of using that edge as part of a preferred path; this desirability can be measured in several different ways, according to the needs of the application, such as requiring the least amount of resources or time required to transition to the new state.) These teachings will accommodate, however, supporting this capability while nevertheless maintaining the stored model itself in an agnostic state with respect to any particular application. That is, the stored model can serve to identify the various contextually-described states that may be relevant to a given application setting and can further identify the various state-to-state transitions as correspond to various pairs of these states, but the corresponding cost as would correlate to a given one of these transitions for a given application is represented in a neutral manner (that is, in a manner that does not evince any particular corresponding application-specific preference).

More particularly, and as is represented in the aforementioned FIG. 2, the cost of a given edge 201 (which represents, as noted above, a corresponding state-to-state transition) is represented by a function f(x). The value of this function, in turn, can be influenced by one or more actions of a policy as corresponds to a given application as described below in more detail.

Referring still to FIG. 1, this process 100 also provides the step 102 of accessing at least one policy as pertains to a particular application to be effected by the enabling processing platform. By one approach, the purpose of this policy is to provide an indication of relative preference as pertains to at least one of the aforementioned state-to-state transitions. In fact, for most real world applications, it is likely that this step will include accessing a plurality of such policies where each such policy presents a particular relative preference as pertains to each of a plurality of state-to-state transitions. By one approach, for example, this can include providing policies that comprise, at least in part, a weighting factor to be applied to the aforementioned state-to-state transitions.

Referring momentarily to FIG. 3, an illustrative example in this regard will be provided. Those skilled in the art will recognize and understand that this example is intended to serve only in an illustrative capacity and is not intended to comprise an exhaustive listing of all possibilities in this regard. The illustrated model 300 graphically depicts a state X and a state Y and four potentially intervening states A-D. As per these teachings, each of these states comprises a contextually-described state. The lines that interconnect various ones of these states are the edges that represent the state-to-state transitions. For example, one of the edges denoted by reference numeral 301 represents the state-to-state transition from state C to state Y while another of the edges, denoted in this case by reference numeral 302, represents the state-to-state transition from state D to state Y.

In this illustrative example, at least some of these edges have a function that comprises a corresponding preference indication (in this case, a weighting factor). For example, the state-to-state transition 201 from state A to state C has function F₁ (x) while the state-to-state transition 301 from state C to state Y has function F₂(x) and the state-to-state transition 302 from state D to state Y has function F₃(x). As initially retrieved as per these teachings, this state model 300 is agnostic with respect to any particular application and these functions, being initially neutral with respect to preference, can essentially represent null values (though other possibilities and approaches are certainly available and possibly useful depending upon the application setting).

As per the above-described step 102 of accessing one or more policies as pertain to a given application, in this example policy 1, policy 2, and policy 3 are accessed. These policies can be utterly independent of one another if desired or, as shown, can be related to one another by one or more tying functions (in this case, a function represented as g(x)). This flexibility, in turn, serves to permit the end user to coordinate or to not coordinate these respective cost functions with one another with respect to some larger scheme or related overall preference(s). There are various ways by which such policies can be accessed. By one approach, these policies (in whole or in part) can comprise a part of the application itself. As another approach, these policies (in whole or in part) can be separate from the application but nevertheless native to the implementing platform. As yet another example in these regards, such policies might be presented in conjunction with the initial retrieval of the stored model itself.

Referring again to FIG. 1, this process 100 also provides the step 103 of applying the accessed policy(ies) to modify the corresponding state-to-state transition(s) to thereby provide a modified version of the stored model that corresponds in particular to the particular application to be affected. As one illustrative example in this regard, when the policies comprise weighting factors that correspond to a relative preference for given state-to-state transitions for the given application, this can comprise applying that weighting factor to the corresponding state-to-state transition.

FIG. 4 presents an illustrative example in this regard. In this example, the particular weighting factors for the given application are applied to their respective state-to-state transitions to thereby provide the aforementioned indications of relative preference. For example, the state-to-state transition from state A to state C has a cost weighting factor of “2” whereas the state-to-state transition from state A to state D has a cost weighting factor of “3.” This can be easily and readily interpreted by the enabling platform to understand that transitioning from state A to state Z, which must necessarily entail an intermediary state of either state C or state D, imposes a lesser cost when the transition path comprises A-C-Z as versus when the transition path comprises A-D-Z.

This simple example will be understood to illustrate the very powerful ability of this approach to permit using an agnostic stored model comprised of various contextually-described states in conjunction with a specific application and its corresponding policies to identify, with great simplicity, clarity, and certainty, an optimum approach to achieving a desired state. This simple example will also help to illustrate the point that a different application, having different corresponding policies, can yield different results in this regard notwithstanding the use of the very same model.

Referring again to FIG. 1, this process 100 will also accommodate the optional step 104 of using this modified version of the stored model when effecting the particular application by the processing platform to facilitate making automated transitions from one state to another. Those skilled in the art will understand that this can comprise, for example, using a version of the model wherein the state-to-state transitions have been weighted as per the unique requirements of a given application to then select not only a particular desired end state (given a particular operating context) but a particular path of transitions through various intermediary states as well.

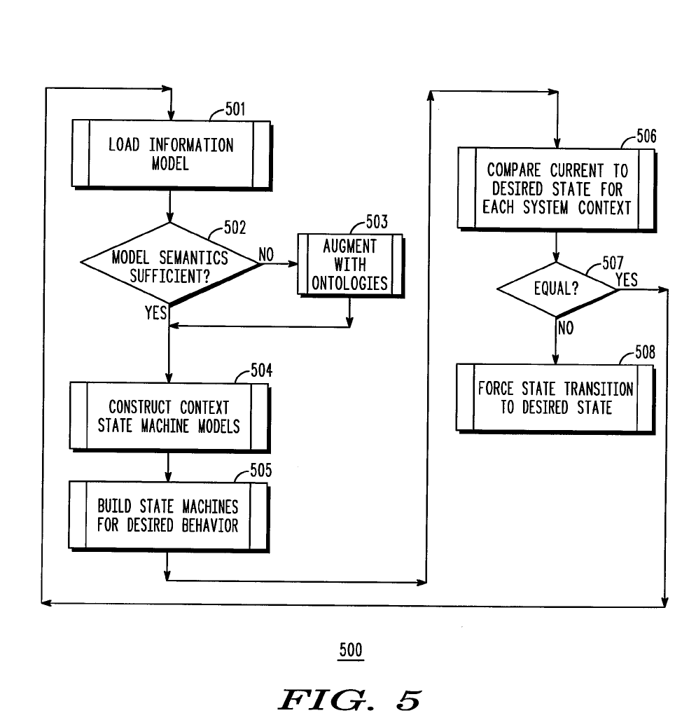

Those skilled in the art will also recognize that these teachings can be employed and leveraged in any of a variety of ways to achieve particular corresponding results and/or benefits. One example in this regard will now be presented with reference to FIG. 5. The described process 500 can be carried out, for example, by an appropriate programmed platform such as a cellular telephone.

In this illustrative process 500 one loads 501 an information model such as the kind of model as has been described herein. A determination 502 can then be made regarding whether the semantics of the model are sufficient for the task at hand. This can comprise, for example, determining whether a given application requires semantics beyond those which the model itself can define.

When not true, this process 500 can provide for augmenting 501 the model using one or more available ontologies 503. (As used herein, this reference to ontologies will be understood to refer to formal representations of corresponding sets of concepts within a given domain and the relationships between those concepts.) These ontologies can be locally available, if desired, or can be accessed via some remote resource that may, or may not, be otherwise associated with the source of the model itself. As noted earlier, the DEN-ng model can be utilized as the basis for the model. Those skilled in the art will recognize that the DEN-ng approach is explicitly constructed to facilitate the integration of ontological data with its own modeled data, thereby making this step relatively straightforward to accomplish. (Further description regarding the use of ontologies to augment the semantics that are modeled in an information model can be found in a previously filed patent application entitled METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS as filed on Jun. 7, 2006 and having been assigned application number 11/422,661, the contents of which application are fully incorporated herein by this reference.)

In any event, this process 500 then provides for constructing corresponding context state machine models to thereby represent each distinctly different context that is relevant. This can comprise, for example, using the aforementioned policies for a given application to characterize and particularize the state-to-state transitions as comprise a part of the model. The resultant particularized model can then serve to facilitate building 505 state machines for one or more desired behaviors as correspond to the implementing platform.

Each such state machine can serve to represent each ManagedEntity to a level of detail as may be required by the particular application. For example, some managed entities may be suitably represented by very simple state machines while others could have state machines with a large number of states (including, for example, nested or hierarchical state machines). The complexity of each state machine can be a function, for example, of how many controllable options a given managed entity (or set of managed entities) have.

Those skilled in the art will recognize that this set of state machines can be collectively used to model the behavior of the managed entities. When each managed entity is in its proper state, the behavior of those managed entities is as expected and can even be predicted according to the accuracy and detail of the corresponding state machine.

The latter can then employ a closed control loop approach and compare 506 one or more current states with the one or more desired states as correspond to these desired behaviors for each system context of interest. When this comparison 506 yields equal results 507, no changes are necessary and the process 500 can repeat if desired to remain current with present contextual influences. When this comparison 506 yields unequal results 507, however, this process 500 can then force 508 a state transition to the desired state for the present context. The particular state-to-state transition utilized for this purpose can be determined using, for example, the previously described weighting factors in conjunction with the loaded model.

As noted previously, the number of potential states in a given model can be large. By one approach, the number of states as are actually utilized with respect to a given application can be controlled, at least to some extent, by using context to eliminate certain states and certain state-to-state transitions from consideration. So long as there is a formal method to define context one can readily limit the number of states that belong to a particular context.

For example, one can employ one or more sets of rules that are used to manage and control the changing and/or maintaining of the state of one or more managed objects as a means of controlling the states that are visited when reconfiguration is required. These teachings will also accommodate the use of FOCALE autonomic architecture principals to select the functionality of a given network or system under consideration. Generally speaking, FOCALE's adaptive control loops can be employed to use context to focus the analysis of incoming context characterizations (in part, for example, by using FOCALE techniques to select only relevant nodes from the model using context-aware policies) and the reconfiguration of managed entities to conform to a desired state as contemplated above.

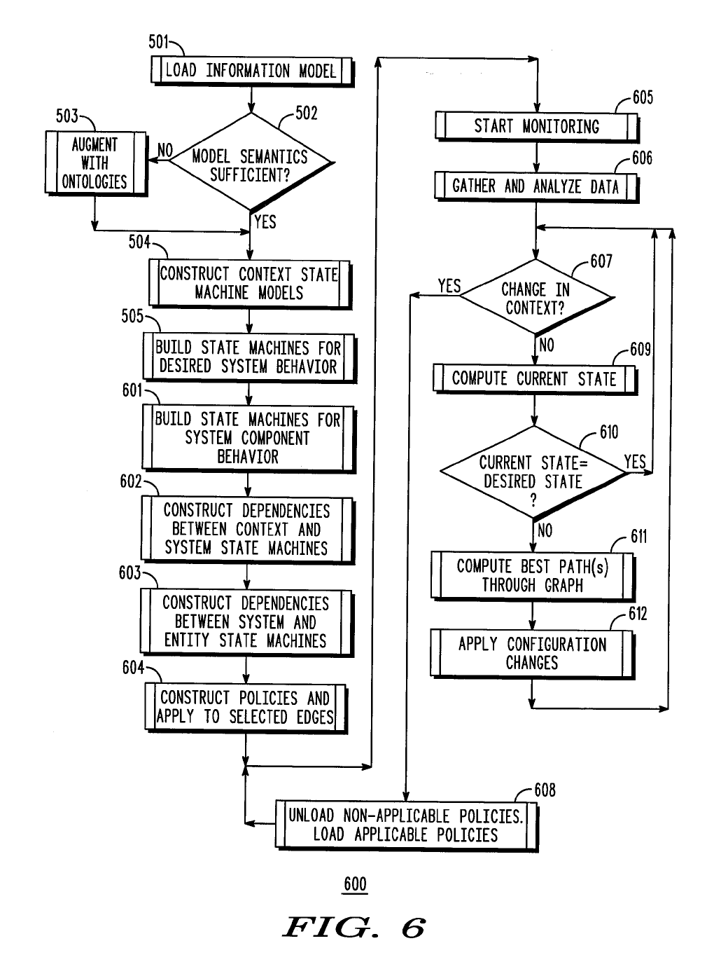

Referring now to FIG. 6, yet another more specific example will be provided. Again, it will be understand that this example serves in an illustrative capacity and without any suggestion that the teachings are limited to the specifics of this example.

Steps 501 through 505 of this process 600 can be as described above with respect to FIG. 5. This process 600 then builds 601 state machines for system component behavior followed by construction 602 of dependencies between context elements and these system state machines as well as the construction 603 of dependencies between the system itself and entity state machines. This process 600 then provides for the resultant construction 604 of corresponding policies to be applied to the selected edges (that is, the state-to-state transitions) of the state machines 505 and/or states machines 601, as appropriate.

A control loop portion of the process 600 begins with a monitoring step 605 that facilitates the gathering and analyzing 606 of data regarding various context components and characterizing information. This input, in turn, permits the process 600 to determine 607 when a change in context occurs. When this in fact occurs, this process 600 then provides, in this illustrative example, for the unloading 608 of non-applicable policies and the loading of applicable policies. In other words, as context changes, this process 600 unloads policies that are no longer relevant and replaces them with new policies that are relevant for this new context.

Presuming no such change in context, this process 600 computes 609 the current state and compares 610 that determination with a given desired state. When this yields a favorable comparison, this process 600 can then loop back to continue the steps of detecting a change to context. When this step yields an unfavorable comparison, this process 600 then computes 611 a best path through the aforementioned graph and applies 612 those configuration changes as appropriate to achieve the desired state.

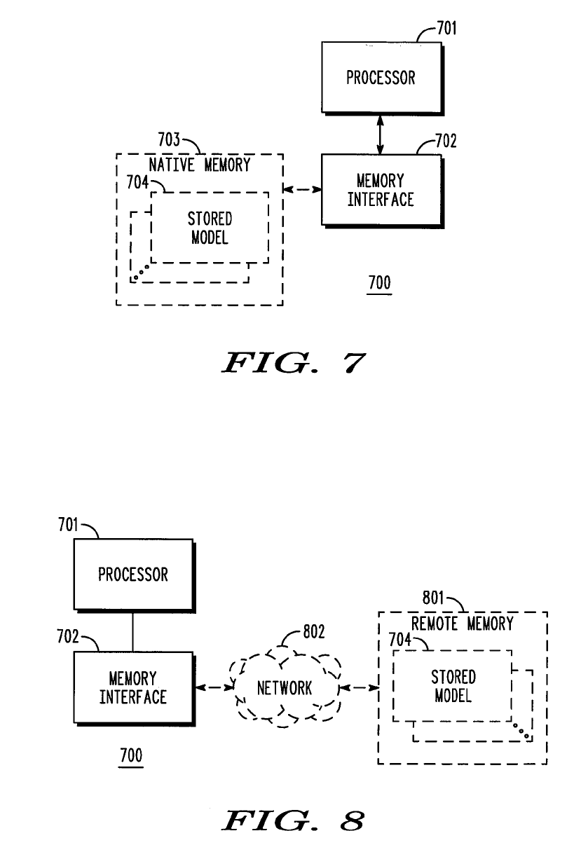

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided.

In this illustrative example, the processing platform 700 has a processor 701 that operably couples to a memory interface 702. Those skilled in the art will recognize and appreciate that such a processor can comprise a fixed-purpose hard-wired platform or can comprise a partially or wholly programmable platform. All of these architectural options are well known and understood in the art and require no further description here. This processor 701 can be configured (using, for example, software programming as will be well understood by those skilled in the art) to carry out one or more of the steps, actions, and functionality as has been set forth herein.

Also in this illustrative example, this processing platform 700 itself further comprises native memory 703 that serves to store one or more of the aforementioned models 704. By this approach, the processing platform 700 contains the model and hence has direct access to the model when effecting a given application using policies as correspond to that application to accordingly revise the model as described herein.

As referenced above, these teachings will also accommodate the remote storage of the model. In such a case, and referring now to FIG. 8, the memory interface 702 can operably couple instead to a remote memory 801 that stores the model 704. As a more specific illustrative example in this regard, this remote memory 801 can reside at a corresponding server. The memory interface 702, in turn, can couple to and access the remote memory 801 by connecting through an intervening network 802 of choice (such as, but not limited to, a cellular telephony network, the Internet, a private intranet, and so forth). Though not specifically illustrated in FIG. 8, those skilled in the art will recognize and understand that there may, in a given application setting, be a plurality of intervening networks between the memory interface 702 and the remote memory 801.

Those skilled in the art will recognize and understand that such an apparatus 700 may be comprised of a plurality of physically distinct elements as is suggested by the illustrations shown in FIGS. 7 and 8. It is also possible, however, to view these illustrations as comprising a logical view, in which case one or more of these elements can be enabled and realized via a shared platform. It will also be understood that such a shared platform may comprise a wholly or at least partially programmable platform as are known in the art.

So configured, those skilled in the art will recognize that these teachings provide a powerful and efficient mechanism by which a given context-sensitive application can be readily supported through use of an agnostic model that can, in turn, be similarly employed with a variety of other applications and application settings. These teachings are highly scalable, such that a given model can be reasonably expected to support a very large number of differing applications.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
accessing a stored model comprised of:
a plurality of candidate contextually-described states; and
state-to-state transitions between at least some of the plurality of candidate contextually-described states;
wherein the stored model is agnostic with respect to any particular application;
accessing at least one policy as pertains to a particular application to be effected by a processing platform;
applying the at least one policy to modify at least one of the state-to-state transitions to thereby provide a modified version of the stored model that corresponds in particular to the particular application to be effected.

2. The method of claim 1 wherein accessing the stored model comprises, at least in part, retrieving the stored model from a location that is remote with respect to the processing platform.

3. The method of claim 1 wherein accessing the stored model comprises, at least in part, retrieving the stored model from a location that is native with respect to the processing platform.

4. The method of claim 1 wherein accessing a stored model comprises accessing a stored model that comprises a graphic representation of the plurality of candidate contextually-described states and the state-to-state transitions.

5. The method of claim 1 wherein the stored model is agnostic with respect to any particular application in that the state-to-state transitions are neutrally represented without any corresponding evinced preference.

6. The method of claim 1 wherein accessing at least one policy comprises accessing at least one policy that comprises, at least in part, an indication of relative preference as pertains to at least one of the state-to-state transitions.

7. The method of claim 6 wherein accessing at least one policy that comprises, at least in part, an indication of relative preference as pertains to at least one of the state-to-state transitions comprises accessing at least one policy that comprises, at least in part, an indication of relative preference as pertains to a plurality of the state-to-state transitions.

8. The method of claim 6 wherein accessing at least one policy that comprises, at least in part, an indication of relative preference as pertains to at least one of the state-to-state transitions comprises accessing at least one policy that comprises, at least in part, a weighting factor to be applied to the at least one of the state-to-state transitions.

9. The method of claim 1 further comprising:
using the modified version of the stored model when effecting the particular application by the processing platform to facilitate making automated transitions from one state to another.

10. An apparatus comprising:
a memory interface;
a processor operably coupled to the memory interface, wherein the processor is configured to:
access, via the memory interface, a stored model comprised of:
a plurality of candidate contextually-described states; and
state-to-state transitions between at least some of the plurality of candidate contextually-described states;
wherein the stored model is agnostic with respect to any particular application;
retrieve at least one policy as pertains to a particular application to be effected by a processing platform;
apply the at least one policy to modify at least one of the state-to-state transitions to thereby provide a modified version of the stored model that corresponds in particular to the particular application to be effected.

11. The apparatus of claim 10 wherein the processor is configured to access the stored model by, at least in part, retrieving the stored model from a location that is remote with respect to the processing platform.

12. The apparatus of claim 10 wherein the processor is configured to access the stored model by, at least in part, retrieving the stored model from a location that is native with respect to the processing platform.

13. The apparatus of claim 10 wherein the processor is configured to access a stored model by accessing a stored model that comprises a graphic representation of the plurality of candidate contextually-described states and the state-to-state transitions.

14. The apparatus of claim 10 wherein the stored model is agnostic with respect to any particular application in that the state-to-state transitions are neutrally represented without any corresponding evinced preference.

15. The apparatus of claim 10 wherein the processor is configured to access at least one policy by accessing at least one policy that comprises, at least in part, an indication of relative preference as pertains to at least one of the state-to-state transitions.

16. The apparatus of claim 15 wherein the processor is configured to access at least one policy that comprises, at least in part, an indication of relative preference as pertains to at least one of the state-to-state transitions by accessing at least one policy that comprises, at least in part, an indication of relative preference as pertains to a plurality of the state-to-state transitions.

17. The apparatus of claim 15 wherein the processor is configured to access at least one policy that comprises, at least in part, an indication of relative preference as pertains to at least one of the state-to-state transitions by accessing at least one policy that comprises, at least in part, a weighting factor to be applied to the at least one of the state-to-state transitions.

18. The apparatus of claim 10 wherein the processor is further configured to:
use the modified version of the stored model when effecting the particular application by the processing platform to facilitate making automated transitions from one state to another.
